(19) United States
(12) Patent Application Publication
(10) Pub. No.: US 2009/0002319 A1
(43) Pub. Date: Jan. 1, 2009

(54) WHEEL MOUSE

(75) Inventor: Yu-Chih Cheng, Taipei (TW)

Correspondence Address: KIRTON AND MCCONKIE, 60 EAST SOUTH TEMPLE,, SUITE 1800, SALT LAKE CITY, UT, 84111, US

(73) Assignee: PRIMAX ELECTRONICS LTD., Taipei (TW)

(21) Appl. No.: 11/952,852

(22) Filed: Dec. 7, 2007

(30) Foreign Application Priority Data
Jun. 29, 2007 (TW) 096123713

(51) Int. Cl. G09G 5/08

(52) U.S. Cl. 345/163

(57) ABSTRACT

The present invention relates to a wheel mouse. The wheel mouse includes a base, an upper cover, a scroll wheel, a first support element, a second support element, and a wheel carrier member. The first and second support elements are disposed on the base and arranged in parallel with the third axial direction. The wheel carrier member is supported by the first and second support elements and includes a fixing piece at a first end thereof and two support pieces at a second end thereof. The fixing piece is attached on the first support element. The support pieces are extended from bilateral sides of the wheel carrier member to the base.

### FIELD OF THE INVENTION

The present invention relates to a wheel mouse, and more particularly to a wheel mouse having a wheel carrier member.

### BACKGROUND OF THE INVENTION

Generally, commercial available wheel mice are usually classified into two major types. By rotating a scroll wheel of the first type wheel mouse, the third-axial rotating function is activated to control uniaxial (e.g. either horizontal or vertical) scrolling operation of the computer monitor. The second type wheel mouse is also referred as a tilt wheel mouse. In addition to the third-axial rotating function by rotating a scroll wheel, the scroll wheel of the tilt wheel mouse may be tilted leftwards or rightwards to control a fourth axial scrolling operation of the computer monitor. That is, the tilt wheel mouse may control both horizontal scroll movement and vertical scroll movement of the images shown on the computer monitor.

FIG. 1 is a schematic perspective view illustrating a conventional wheel mouse having a third-axial rotating function. The wheel mouse 100 of FIG. 1 principally includes a base 101, two support elements 102 and a scroll wheel 106. The support elements 102 are disposed on the base 101. A wheel shaft 107 is penetrated through the center of the scroll wheel 106 and supported on the support elements 102. The support elements 102 are perpendicular to the third axial direction, i.e. the rotating direction A of the scroll wheel 106. Both ends of the support elements 102 are disposed on bilateral sides of the scroll wheel 106. Since the wheel shaft 107 is supported by the support elements 102, the scroll wheel 106 may be rotated in the axial direction A. At the locations corresponding to the left click button (not shown), the right click button (not shown) and a first end of the wheel shaft 107, the wheel mouse 100 further includes a left-button micro switch 103, a right-button micro switch 104 and a wheel micro switch 105 on the base 101, respectively. The left click button and the right click button are mounted on an upper cover (not shown) of the wheel mouse 100. Moreover, the upper cover has an opening, and the scroll wheel 106 partially penetrates through the opening such that the scroll wheel 106 can be rotated by a user. The second end of the wheel shaft 107 is inserted into a mechanical encoder 108. Upon rotation of the scroll wheel 106, the encoding disc inside the mechanical encoder 108 will be rotated so as to generate a scrolling control signal.

The wheel mouse having a fourth axle function will be illustrated with reference to FIG. 2. Referring to FIG. 2, a schematic perspective view of a conventional tilt wheel mouse is illustrated. The tilt wheel mouse 200 of FIG. 2 principally includes a base 201, a first support element 202, a second support element 203, a scroll wheel 208 and a wheel carrier member 210. The first support element 202 and the second support element 203 are disposed on the base 201 for supporting the wheel carrier member 210. The wheel shaft 2081 of the scroll wheel 208 is supported by the wheel carrier member 210 such that the scroll wheel 208 is partially received in the wheel carrier member 210. The first support element 202 and the second support element 203 are arranged in parallel with the axial direction A of the scroll wheel 208. The first support element 202 and the second support element 203 are respectively arranged near the front end and the rear end of the scroll wheel 208. As a result, the scroll wheel 208 may be tilted toward the left or right side. At the locations corresponding to the left click button (not shown), the right click button (not shown), a triggering shaft 2103 of the wheel carrier member 210 and the left and right sides of the scroll wheel 208, the tilt wheel mouse 200 further includes a left-button micro switch 204, a right-button micro switch 205, a wheel micro switch 206, a wheel left-side tilt micro switch 207 and a wheel right-side tilt micro switch 208 on the base 101, respectively.

FIG. 3 is a schematic perspective view illustrating the wheel carrier member of the tilt wheel mouse in FIG. 2. Please refer to FIGS. 2 and 3. The front end of the wheel carrier member 210 is supported on the first support element 202. The rear end of the wheel carrier member 210 is formed as the triggering shaft 2103, which is disposed above the wheel micro switch 206 and supported on the second support element 203. In a case that the scroll wheel 208 is pressed down, the triggering shaft 2103 of the wheel carrier member 210 is moved downwardly to trigger the wheel micro switch 206, thereby generating a switching signal. Furthermore, a receptacle 2102 is formed in a second sidewall 2101 of the wheel carrier member 210 for receiving a mechanical encoder 209 therein (as shown in FIG. 2).

The main differences between the tilt wheel mouse of FIG. 2 and the first type wheel mouse of FIG. 1 include the orientations of the support elements and the presence or absence of the wheel carrier member. As previously described, the support elements of the first type wheel mouse having a third-axial rotating function are the rotating direction of the scroll wheel such that the scroll wheel is rotatable. Whereas, in addition to third-axial rotation, the scroll wheel of the tilt wheel mouse may be tilted toward the left or right side. For tilting the scroll wheel toward the left or right side, the wheel carrier member of the tilt wheel mouse is necessary and the first and second support elements for supporting the wheel carrier member are arranged in parallel with the axial direction of the scroll wheel. In practical, the manufacturer may only produce one of the first type wheel mouse and second type wheel mouse, for example the first type wheel mouse in views of economy. If the appearance of the selected wheel mouse sells well on markets, the manufacturer may produce another type wheel mouse (e.g. the tilt wheel mouse) having the similar appearance. Since these two types of wheel mice have different structures, the upper covers thereof are different and the manufacturer needs two mold sets for fabricating respective upper covers. That is, for producing another type wheel mouse, a new mold set should be developed. Generally, it takes two or three month to design and make a new mold set. Therefore, the producing efficiency is unsatisfied and the fabricating cost is increased.

In views of the above-described disadvantages resulted from the prior art, the applicant keeps on carving unflaggingly to develop an improved wheel mouse according to the present invention through wholehearted experience and research.

### SUMMARY OF THE INVENTION

It is an object of the present invention to provide a wheel mouse, and more particularly to a wheel mouse exchangeable between a first type wheel mouse having the third-axial rotating function and a tilt wheel mouse without the need of changing the mouse's upper cover.

In accordance with an aspect of the present invention, there is provided a wheel mouse. The wheel mouse includes a base, an upper cover, a scroll wheel, first and second support elements, and a wheel carrier member. The upper cover shelters the base and has an opening. The scroll wheel partially penetrates through the opening such that the scroll wheel is rotatable in a third axial direction, wherein the scroll wheel has a wheel shaft. The first and second support elements are disposed on the base and arranged in parallel with the third axial direction. The wheel carrier member is used for supporting the wheel shaft and permitting rotation of the scroll wheel therein. The wheel carrier member is supported by the first and second support elements and includes a fixing piece at a first end thereof and two support pieces at a second end thereof. The fixing piece is attached on the first support element. The support pieces are extended from bilateral sides of the wheel carrier member to the base.

In an embodiment, a receptacle is formed in a sidewall of the wheel carrier member for receiving an encoder therein.

Preferably, the encoder is a mechanical encoder.

In an embodiment, a triggering shaft is extended from the second end of the wheel carrier member for trigger a micro switch under the triggering shaft.

In an embodiment, the wheel carrier member is integrally formed.

In an embodiment, the first and second support elements are integrally formed with the base.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1 is a schematic perspective view illustrating a conventional wheel mouse having a third-axial rotating function;

FIG. 2 is a schematic perspective view of a conventional tilt wheel mouse;

FIG. 3 is a schematic perspective view illustrating the wheel carrier member of the tilt wheel mouse in FIG. 2;

FIG. 4 is a schematic perspective view illustrating a wheel carrier member for use in a wheel mouse according to a preferred embodiment of the present invention; and

FIGS. 5(a) and 5(b) are schematic perspective views illustrating a wheel mouse of the present invention taken from two different viewpoints.

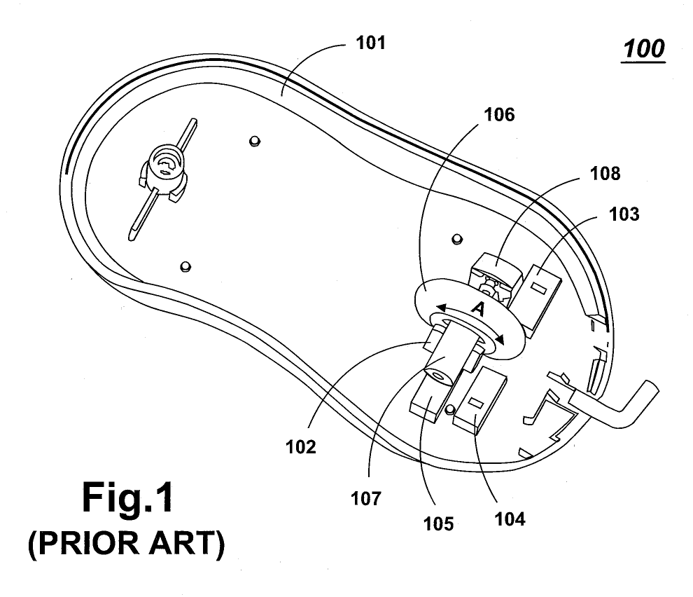

### DETAILED DESCRIPTION OF THE PREFERRED EMBODIMENT

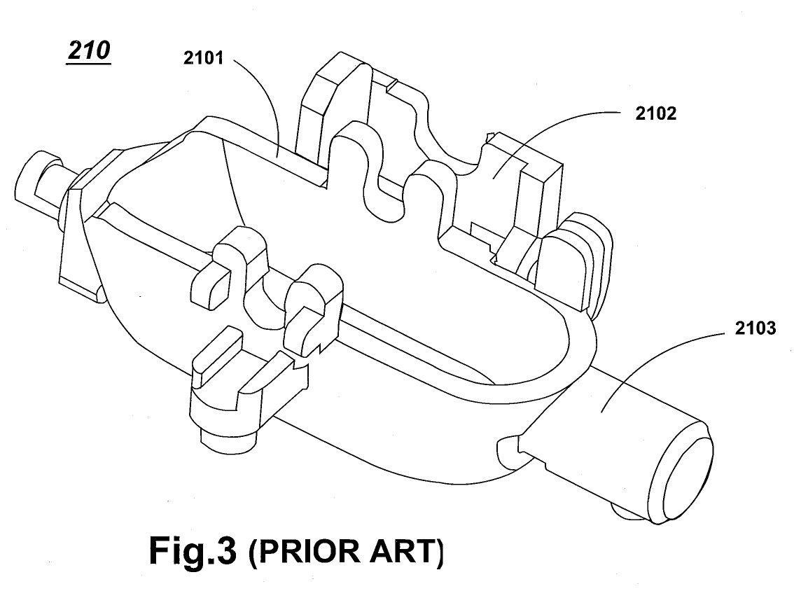

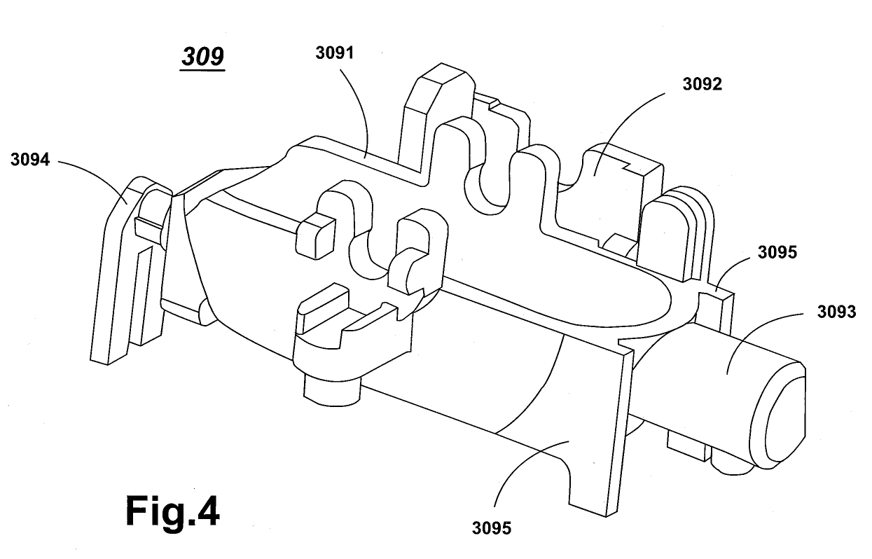

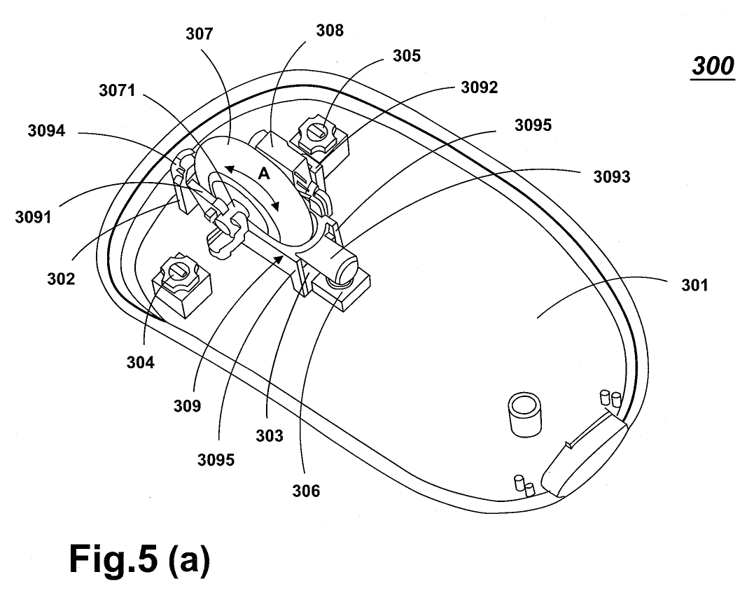

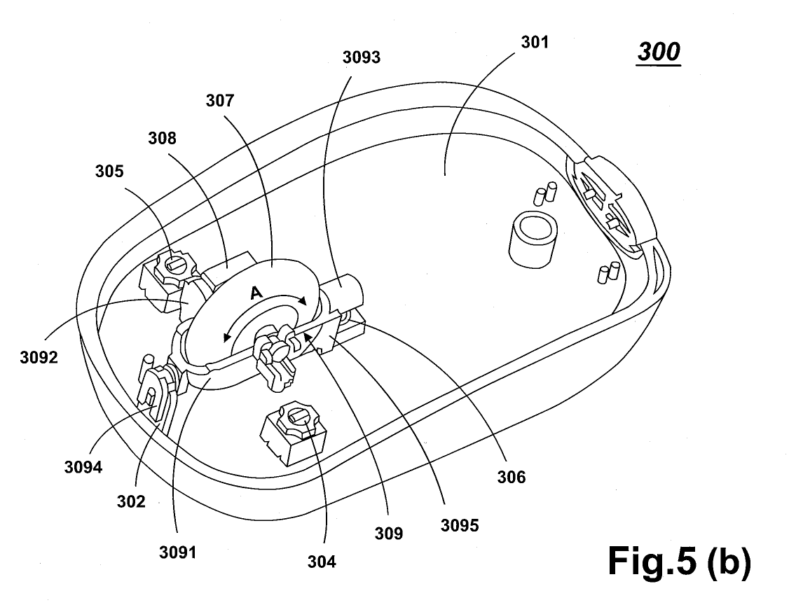

FIG. 4 is a schematic perspective view illustrating a wheel carrier member for use in a wheel mouse according to a preferred embodiment of the present invention. In the wheel carrier member 309 of FIG. 4, a receptacle 3092 is formed in a second sidewall 3091 of the wheel carrier member 309 for receiving an encoder 308 therein and the rear end of the wheel carrier member 309 is formed as a triggering shaft 3093 to trigger a micro switch 306 (as shown in FIG. 5(a)). The structure of the wheel carrier member of FIG. 4 is substantially identical to that of FIG. 3 except that the wheel carrier member of FIG. 4 further includes a fixing piece 3094 and two support pieces 3095. By means of the fixing piece 3094 and the support pieces 3095, the wheel carrier member 309 is fixed without tilting to the left or right side. More preferably, the wheel carrier member 309 is integrally formed.

FIGS. 5(a) and 5(b) are schematic perspective views illustrating a wheel mouse of the present invention taken from two different viewpoints. As shown in FIG. 5(a), the wheel mouse 300 principally includes a base 301, a first support element 302, a second support element 303, a scroll wheel 307 and the wheel carrier member 309. The first support element 302 and the second support element 303 are disposed on the base 301 for supporting the wheel carrier member 309. The first support element 302 and the second support element 303 are arranged in parallel with the axial direction A of the scroll wheel 307. In an embodiment, the first support element 302 and the second support element 303 are integrally formed with the base 301. The wheel shaft 3071 of the scroll wheel 307 is supported by the wheel carrier member 309 such that the scroll wheel 307 is partially received in the wheel carrier member 309 and rotatable in the wheel carrier member 309. The first support element 302 and the second support element 303 are respectively arranged near the front end and the rear end of the scroll wheel 307. The encoder 308 is received in the receptacle 3092 of the wheel carrier member 309. An example of the encoder 308 includes but is not limited to a mechanical encoder or an optical encoder. The fixing piece 3094 is attached on the first support element 302 and coupled with the front end of the wheel carrier member 309 such that the front end of the wheel carrier member 309 is fixed on the first support element 302 (as is also seen in FIG. 5(b)).

Please refer to FIG. 5(a) again. The two support pieces 309 are extended downwardly from bilateral sides of the wheel carrier member 309 to the base 301. Via the support pieces 309, the wheel carrier member 309 is contacted with the base 301 such that the wheel carrier member 309 is not easily tilted upon rotation of the scroll wheel 307. By means of the fixing piece 3094 and the support pieces 3095, the wheel carrier member 309 is fixed without tilting to the left or right side. In addition, a left-button micro switch 304, a right-button micro switch 305 and a wheel micro switch 306 are provided on the base 301. The operation principles of these three micro switches are known in the art, and are not redundantly described herein.

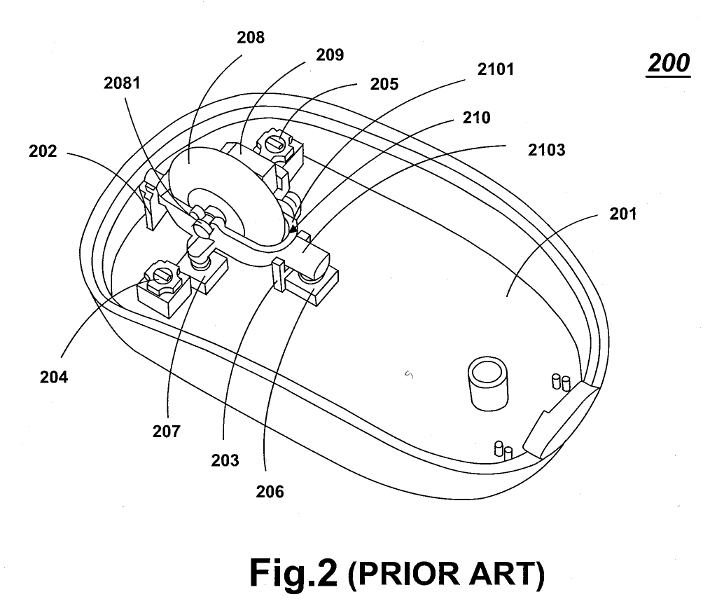

The wheel mouse of FIG. 5 is the first type wheel mouse which has a third-axial rotating function. For rebuilding the first type wheel mouse of FIG. 5 into a tilt wheel mouse, the wheel carrier member 309 is firstly removed and then replaced with any wheel carrier member suitable for the tilt wheel mouse (e.g. the wheel carrier member 210 shown in FIG. 3). On the other hand, by replacing the wheel carrier member 210 of the tilt wheel mouse 200 of FIG. 2 with the wheel carrier member 309 of the present invention, the first type wheel mouse which has the third-axial rotating function is assembled. Since the first type wheel mouse and the second type mouse are exchangeable with each other by using the wheel carrier member of the present invention, only one mold set is sufficient to fabricate the mouse's upper cover.

As known, the circuit configurations for the first type wheel mouse and the second type mouse are different. The adjustment of the circuit configuration includes the change of the electronic components' layout on the circuit board without influencing the efficacy of using only one mold set to fabricate the mouse's upper cover.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A wheel mouse comprising:
a base;
an upper cover sheltering said base and having an opening;
a scroll wheel partially penetrating through said opening such that said scroll wheel is rotatable in a third axial direction, wherein said scroll wheel has a wheel shaft;
a first support element and a second support element disposed on said base and arranged in parallel with said third axial direction; and
a wheel carrier member for supporting said wheel shaft and permitting rotation of said scroll wheel therein, said wheel carrier member being supported by said first and second support elements and including a fixing piece at a first end thereof and two support pieces at a second end thereof, wherein said fixing piece is attached on said first support element, and said support pieces are extended from bilateral sides of said wheel carrier member to said base.

2. The wheel mouse according to claim 1 wherein a receptacle is formed in a sidewall of said wheel carrier member for receiving an encoder therein.

3. The wheel mouse according to claim 2 wherein said encoder is a mechanical encoder.

4. The wheel mouse according to claim 1 wherein a triggering shaft is extended from said second end of said wheel carrier member for trigger a micro switch under said triggering shaft.

5. The wheel mouse according to claim 1 wherein said wheel carrier member is integrally formed.

6. The wheel mouse according to claim 1 wherein said first and second support elements are integrally formed with said base.
